(19) United States
(12) Patent Application Publication
(10) Pub. No.: US 2013/0250091 A1
(43) Pub. Date: Sep. 26, 2013

(54) IMAGE PROCESSING APPARATUS, IMAGE PROCESSING SYSTEM, IMAGE PROCESSING METHOD, AND PROGRAM

(71) Applicant: CANON KABUSHIKI KAISHA, Tokyo (JP)

(72) Inventors: Tomohiko Takayama, Tokyo (JP); Takuya Tsujimoto, Kawasaki-shi (JP); Kazuyuki Sato, Yokohama-shi (JP); Minoru Kusakabe, Yokohama-shi (JP)

(73) Assignee: CANON KABUSHIKI KAISHA, Tokyo (JP)

(21) Appl. No.: 13/797,613

(22) Filed: Mar. 12, 2013

(30) Foreign Application Priority Data
Mar. 23, 2012 (JP) 2012-067578

(51) Int. Cl. H04N 7/18

(52) U.S. Cl. CPC H04N 7/18
USPC 348/80

(57) ABSTRACT

An image processing apparatus that generates data of a display image from data on layer images having different resolutions includes a detection unit that detects a scroll or magnification change request, and a display image generation unit that generates the display image data based on the request, in which the display image generation unit determines whether the request is a high or low speed request when the display image data having a resolution different from those of the layer images is generated, generates the display image data through enlargement processing on data of any of the layer images having a resolution lower than that of the display image when the request is the high speed request, and generates the display image data through reduction processing on data of any of the layer images having a resolution higher than that of the display image in case of the low speed request.

### BACKGROUND

1. Field of the Disclosure

Aspects of the present invention generally relate to an image processing apparatus, an image processing system, an image processing method, and a program.

2. Description of the Related Art

A virtual slide system attracts attention in which an image of a sample on a mount is picked up by a digital microscope to obtain a virtual slide image, and this virtual slide image can be displayed on a monitor to be observed (see Japanese Patent Laid-Open No. 2011-118107).

As a high definition and high resolution image data structure such as the virtual slide image, images having different resolutions are displayed in a hierarchical structure (see Japanese Patent Laid-Open No. 2010-87904).

An image processing technology for realizing a natural scroll display and a high speed scroll has been proposed (see Japanese Patent Laid-Open No. 2011-198249).

In a case where image data regarding the resolution of the display image does not exist in the hierarchical structure disclosed in Japanese Patent Laid-Open No. 2010-87904, a characteristic in which the display image is to be generated from hierarchical image data exists in terms of the image structure. Thus, a natural scroll display can be realized by adopting the technology proposed in Japanese Patent Laid-Open No. 2011-198249, but a problem occurs that it is difficult to realize the high speed scroll.

Japanese Patent Laid-Open No. 2010-87904 discloses a mode of using image data in an adjacent layer in a case where the image data regarding the resolution of the display image does not exist in the hierarchical structure. In this case, a problem occurs that read of the image data on the high speed scroll takes time, and a situation is established where it is difficult to conduct a scroll operation at a satisfactory responsiveness.

### SUMMARY

In view of the above, the present disclosure provides an image processing apparatus that processes hierarchical image data so that it is possible to conduct an operation at an excellent responsiveness.

An image processing apparatus that generates data of a display image from hierarchical image data of a plurality of layer images having different resolutions, the image processing apparatus including: a detection unit configured to detect a scroll request or a magnification change request; and a display image generation unit configured to generate the data of the display image based on the detected request, in which the display image generation unit determines whether the request is a high speed request or a low speed request based on a predetermined value used as a reference when the display image has a resolution different from the resolutions of the plurality of layer images, the display image generation unit generates the display image data by performing enlargement processing on data on any of the layer images that has a resolution lower than the resolution of the display image when the detected request is determined as the high speed request, and the display image generation unit generates the data of the display image by performing reduction processing on data on any of the layer images that has a resolution higher than the resolution of the display image when the detected request is determined as the low speed request.

Further features of the present disclosure will become apparent from the following description of exemplary embodiments with reference to the attached drawings.

### BRIEF DESCRIPTION OF THE DRAWINGS

FIG. 1 is an overall view of an apparatus configuration of an image processing system according to an embodiment.

FIG. 2 is a function block diagram of an image pickup apparatus according to an embodiment.

FIG. 3 is a hardware configuration diagram of an image processing apparatus according to an embodiment.

FIG. 4 is a function block diagram of a control unit in the image pickup apparatus according to an embodiment.

FIG. 5 is a frame format of a structure of hierarchical image data according to an embodiment.

FIG. 6 is a frame format of an explicit display area for the hierarchical image data according to an embodiment.

FIG. 7 is a flow chart for describing a hierarchical image data obtaining method according to an embodiment.

FIG. 8 is a flow chart for describing a generation method for display candidate image data according to an embodiment.

FIG. 9 is a flow chart for describing an image data processing method with response to a scroll request according to an embodiment.

FIG. 10 is a flow chart for describing a display image data transfer method according to an embodiment.

FIG. 11 is a function block diagram of the image processing apparatus to which a POI information processing function is added according to an embodiment.

FIG. 12 is a flow chart for describing display image data output to which the POI information processing function is added according to an embodiment.

FIGS. 13A and 13B are frame formats of hierarchical image data having a depth structure according to an embodiment.

FIG. 14 is a frame format for describing an in-focus degree of a depth image according to an embodiment.

FIG. 15 is a flow chart for describing an insufficiently-focused image data processing in response to the high speed scroll request according to the modified example.

FIG. 16 is a flow chart for describing an image data processing method in response to a low speed scroll request according to an embodiment.

FIG. 17 is a flow chart for describing a display image data output method in response to the high speed scroll request according to an embodiment.

FIGS. 18A to 18D illustrate scroll image examples according to an embodiment.

FIG. 19 illustrates a pop-up display according to an embodiment.

### DESCRIPTION OF THE EMBODIMENTS

Hereinafter, embodiments of the present invention will be described with reference to the drawings.

### First Embodiment

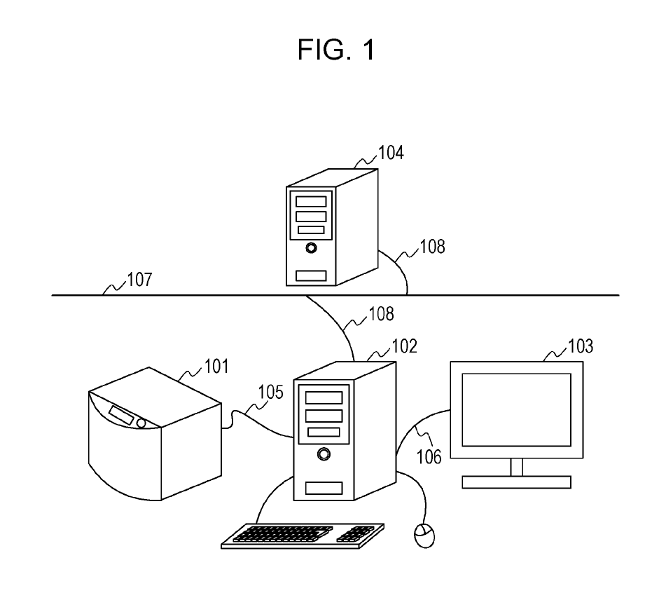

An image processing system according to a first embodiment will be described by using FIG. 1.

FIG. 1 illustrates the image processing system according to the present embodiment. The image processing system is composed of an image pickup apparatus 101, an image processing apparatus 102, a display apparatus 103, and a data server 104. The image processing system is a system having a function of obtaining and displaying a two-dimensional image of a sample corresponding to an image pickup target. A dedicated-use or general-use I/F (interface) cable 105 connects between the image pickup apparatus 101 and the image processing apparatus 102. A general-use I/F cable 106 connects between the image processing apparatus 102 and the display apparatus 103. A general-use I/F LAN cable 108 connects between the data server 104 and the image processing apparatus 102 via a network 107.

The image pickup apparatus 101 is a virtual slide apparatus (virtual slide scanner) having a function of picking up plural two-dimensional images at different locations in a two-dimensional planar direction (XY direction) and outputting digital images. A solid state image pickup device such as a CCD (Charge Coupled Device) or a CMOS (Complementary Metal Oxide Semiconductor) is used to obtain the two-dimensional image. The image pickup apparatus 101 can also be composed of a digital microscope apparatus in which a digital camera is attached to an eye piece of a general optical microscope instead of the virtual slide apparatus.

The image processing apparatus 102 is an apparatus having a function of generating data to be displayed on the display apparatus 103 from original image data of the plural images obtained from the image pickup apparatus 101 on the basis of the original image data in accordance with a request from a user and the like. The image processing apparatus 102 is composed of a general-use computer or a work station provided with hardware resources such as various I/F's including a CPU (Central Processing Unit), a RAM, a storage apparatus, and an operation unit. The storage apparatus is a large-capacity information storage apparatus such as a hard disk drive. The storage apparatus stores a program for realizing respective processings which will be described below, data, an OS (Operation System), and the like. The respective functions are realized while the CPU loads the program and data used for the RAM from the storage apparatus and execute the program. The operation unit is composed of a key board, a mouse, and the like. The operation unit is utilized for an operator to input various inputs.

The display apparatus 103 is a display that displays an observation image corresponding to a result of the computation processing by the image processing apparatus 102. The display apparatus 103 is composed of a CRT, a liquid crystal display, or the like.

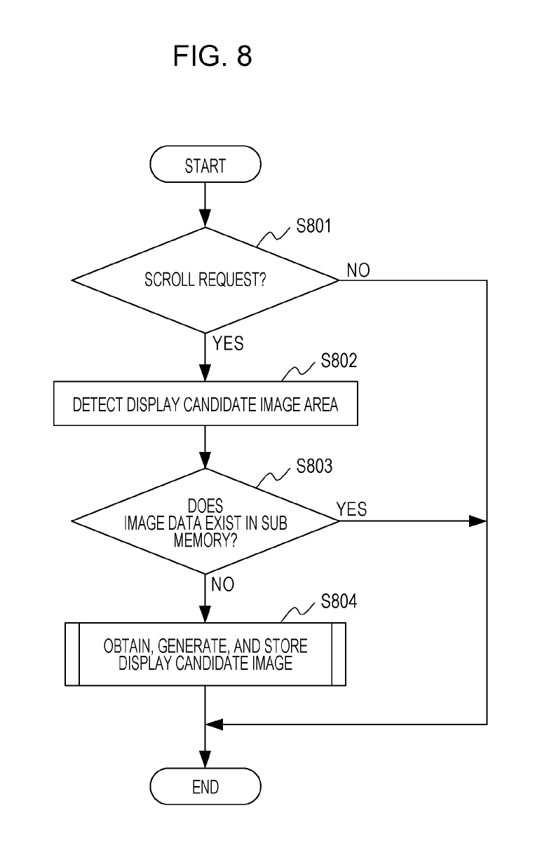

The data server 104 is a server storing diagnosis reference information (data related to a diagnosis reference) used as a guideline by the user when the user diagnoses the sample. The diagnosis reference information is updated as appropriate in accordance with an actual state of a pathologic diagnosis. The data server 104 updates the storage contents in accordance with the update of the diagnosis reference information. The diagnosis reference information will be described below by using FIG. 8.

In the example of FIG. 1, the image pickup system is composed of the four apparatuses including the image pickup apparatus 101, the image processing apparatus 102, the display apparatus 103, and the data server 104, but the configuration is not limited to this configuration. The image processing apparatus integrated with the display apparatus may be used, or the function of the image processing apparatus may be incorporated in the image pickup apparatus, for example. The image pickup apparatus, the image processing apparatus, the display apparatus, and the functions of the data server can also be realized by a single apparatus. The functions of the image processing apparatus and the like may be divided and realized by plural apparatuses.

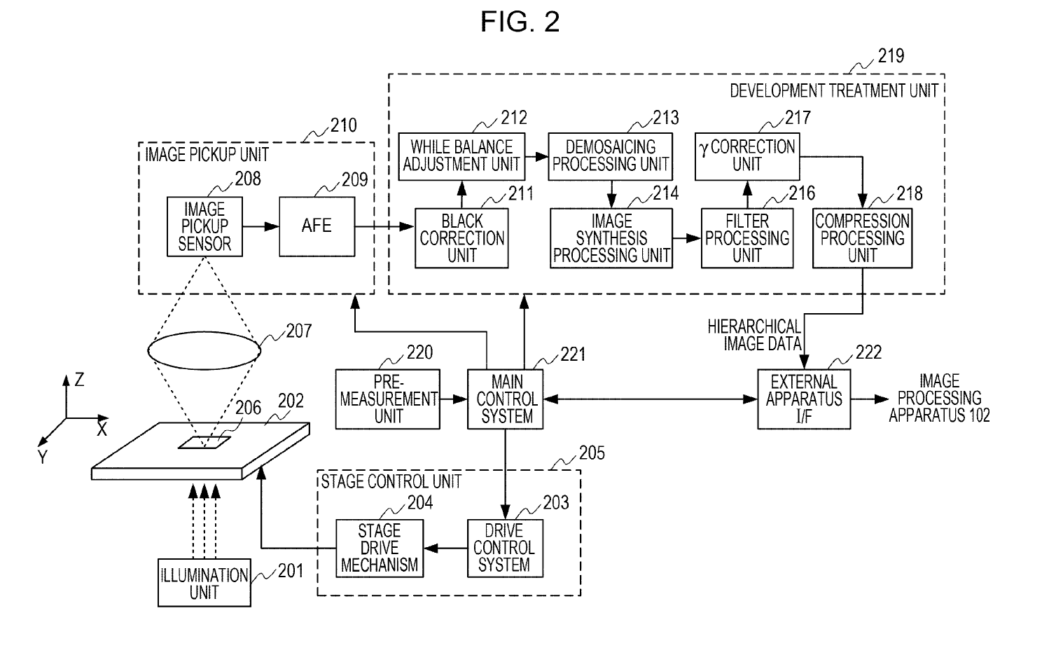

FIG. 2 is a block diagram of a function configuration of the image pickup apparatus 101. The image pickup apparatus 101 is mainly composed of an illumination unit 201, a stage 202, a stage control unit 205, an imaging optical system 207, an image pickup unit 210, a development treatment unit 219, a pre-measurement unit 220, a main control system 221, and an external apparatus I/F 222.

The illumination unit 201 is a unit configured to uniformly irradiate a slide 206 arranged on the stage 202 with light. The illumination unit 201 is composed of a light source, an illumination optical system, and a control system for a light source drive. The stage 202 is driven and controlled by the stage control unit 205 and can move in three axes of XYZ. The slide 206 has a tissue slice or smear cell corresponding to an observation target affixed on slide glass and is fixed under cover glass with mounting agent.

The stage control unit 205 is composed of a drive control system 203 and a stage drive mechanism 204. The drive control system 203 performs a drive control on the stage 202 in response to an instruction of the main control system 221. A movement direction, a movement amount, and the like of the stage 202 are determined on the basis of sample location information and thickness direction (distance information) measured by the pre-measurement unit 220 and an instruction from the user as appropriate. The stage drive mechanism 204 drives the stage 202 in accordance with an instruction of the drive control system 203.

The imaging optical system 207 is a lens group for imaging an optical image of the sample on the slide 206 onto an image pickup sensor 208.

The image pickup unit 210 is composed of the image pickup sensor 208 and analog front end (AFE) 209. The image pickup sensor 208 is a one-dimensional or two-dimensional image sensor configured to convert a two-dimensional optical image into an electric physical quantity through a photoelectric conversion. A CCD or a CMOS device is used for the image pickup sensor 208, for example. In the case of the one-dimensional sensor, a two-dimensional image is obtained through scanning in a scanning direction. An electric signal having a voltage value in accordance with a light intensity is output from the image pickup sensor 208. In a case where a color image is used as a picked-up image, for example, a single image sensor to which a Bayer-array color filter is attached may be used. The image pickup unit 210 picks up divided images of the sample while the stage 202 drives in a direction of XY axes.

The AFE 209 is a circuit configured to convert an analog signal output from the image pickup sensor 208 into a digital signal. The AFE 209 is composed of an H/V driver which will be described below, a CDS (Correlated Double Sampling), an amplifier, an AD converter, and a timing generator. The H/V driver converts a vertical synchronization signal and a horizontal synchronization signal for driving the image pickup sensor 208 into potentials used for the sensor drive. The CDS is a correlated double sampling circuit that removes fixed pattern noise. The amplifier is an analog amplifier that adjusts a gain of an analog signal from which the noise is removed in the CDS. The AD converter converts an analog signal into a digital signal. In a case where an output in a last stage of the image pickup apparatus is 8-bit output, the AD converter converts the analog signal into digital data quantized in a range of approximately 10 bits and 16 bits to be output while taking processing in a subsequent stage into account. The converted sensor output data is referred to as RAW data. The RAW data is subjected to development treatment in the development treatment unit 219 in a subsequent stage. The timing generator generates signals for adjusting a timing of the image pickup sensor 208 and a timing of the development treatment unit 219.

In a case where the CCD is used as the image pickup sensor 208, the AFE 209 is adopted. In a case where a CMOS image sensor that can perform a digital output is used as the image pickup sensor 208, the function of the AFE 209 is included in the sensor. Although not illustrated in the drawing, an image pickup control unit configured to perform a control on the image pickup sensor 208 exists. The image pickup control unit performs an operation control on the image pickup sensor 208, an operation timing such as a shutter speed, a frame rate, and an ROI (Region Of Interest), and a control.

The development treatment unit 219 is composed of a black correction unit 211, a while balance adjustment unit 212, a demosaicing processing unit 213, an image synthesis processing unit 214, a filter processing unit 216, a γ correction unit 217, and a compression processing unit 218. The black correction unit 211 performs processing of subtracting black correction data obtained at the time of light shielding from respective pixels of the RAW data. The while balance adjustment unit 212 performs processing of reproducing wanted while color by adjusting gains of the respective RGB colors in accordance with color temperatures of the light of the illumination unit 201. White balance correction data is added to the RAW data after the black correction. In a case where a single color image is dealt with, the while balance adjustment processing is not conducted.

The demosaicing processing unit 213 performs processing of generating image data of the respective RGB colors from the Bayer-array RAW data. The demosaicing processing unit 213 calculates values of RGB colors of a target pixel by interpolating values of peripheral pixels in the RAW data (including same color pixels and different color pixels). The demosaicing processing unit 213 also executes correction processing (interpolating processing) for a defect pixel. In a case where the image pickup sensor 208 does not include a color filter and a single color is obtained, demosaicing processing is not conducted.

The image synthesis processing unit 214 performs processing of joining image data obtained by dividing an image pickup range by the image pickup sensor 208 to each other and generating large-capacity image data of a wanted image pickup range. Since a sample existence range is generally wider than the image pickup range that can be picked up through a signal image pickup by an image sensor in related art, the single two-dimensional image data is generated by joining the divided pieces of image data to each other. In a case where it is assumed that a range of 10 mm×10 mm on the slide 206 is picked up at a resolution at 0.25 μm, for example, the number of pixels on one side is 40,000 pixels based on 10 mm/0.25 μm, and the total number of pixels is 1,600,000,000 based on the square of 40,000. In order that image data of 1,600,000,000 pixel is obtained by using the image pickup sensor 208 including 10M (10,000,000) pixels, the image pickup is conducted by dividing the area into 160 parts based on 1,600,000,000/10,000,000. A method of joining the plural pieces of image data to each other includes a joining method through alignment based on the location information of the stage 202, a joining method of matching corresponding points or lines of the plural divided images with each other, a joining method based on the location information on the divided image data, and the like. At the time of joining, it is possible to join the plural pieces of image data to each other through interpolation processing such as a zero-order interpolation, a linear interpolation, or a higher-order interpolation. According to the present embodiment, it is assumed that a single large-capacity image is generated, but a configuration of joining the obtained divided images to each other at the time of display data generation may be adopted as a function of the image processing apparatus 102.

The filter processing unit 216 is a digital filter that realizes suppression of a high frequency component included in the image, noise removal, and an emphasis on image resolving sense.

The γ correction unit 217 executes processing of adding an opposite characteristic to the image in accordance with a gray scale representation characteristic of a general display device and a gray scale conversion in accordance with a human visual characteristic through gray scale compression at a high luminance part or dark part processing. Since the image is obtained to obverse a figure according to the present embodiment, gray scale conversion appropriate to synthesis processing and display processing in a subsequent stage is applied to the image data.

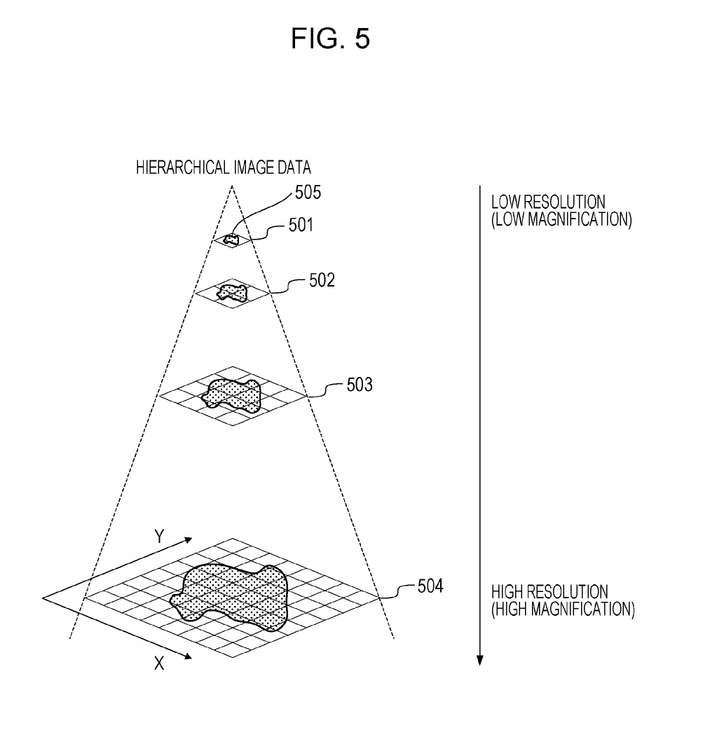

The compression processing unit 218 executes compression coding processing for increasing the efficiency of the transmission of the large-capacity two-dimensional image data and reducing the capacity when the data is saved. A compression technique for still images includes JPEG (Joint Photographic Experts Group), JPEG 2000 where JPEG is improved and advanced, and a standardized coding system such as JPEG XR. The hierarchical image data is generated by executing reduction processing on the two-dimensional image data. The hierarchical image data will be described below by using FIG. 5.

The pre-measurement unit 220 performs pre-measurement to calculate location information on the sample on the slide 206, distance information up to a wanted focal position, and a parameter for a light quantity adjustment attributable to a sample thickness. It is possible to execute the efficient image pickup by obtaining information by the pre-measurement unit 220 before a main measurement (obtaining of picked-up image data). A two-dimensional image pickup sensor having lower resolving power than the image pickup sensor 208 is used to obtain location information on the two-dimensional plane. The pre-measurement unit 220 grasps the location of the sample on the XY plane from the obtained image. A displacement gauge or a Shack Hartman system measuring instrument is used to obtain the distance information and the thickness information.

The main control system 221 has a function of performing the controls on the respective types of units described above. The control functions of the main control system 221 and the development treatment unit 219 are realized by a control circuit including a CPU, a ROM, and a RAM. The functions of the main control system 221 and the development treatment unit 219 are realized while a program and a data are stored in the ROM, and the CPU executes the program by using the RAM as a work memory. A device such as an EEPROM or a flash memory is used for the ROM, for example. A DRAM device such as DDR3 is used for the RAM, for example. The function of the development treatment unit 219 may be replaced by an application specific integrated circuit as a dedicated-use hardware device.

The external apparatus I/F 222 is an interface designed for sending the hierarchical image data generated by the development treatment unit 219 to the image processing apparatus 102. The image pickup apparatus 101 and the image processing apparatus 102 are connected with each other by an optical communication cable. A general-use interface such as USB or Gigabit Ethernet (registered trademark) may alternatively be used for the connection.

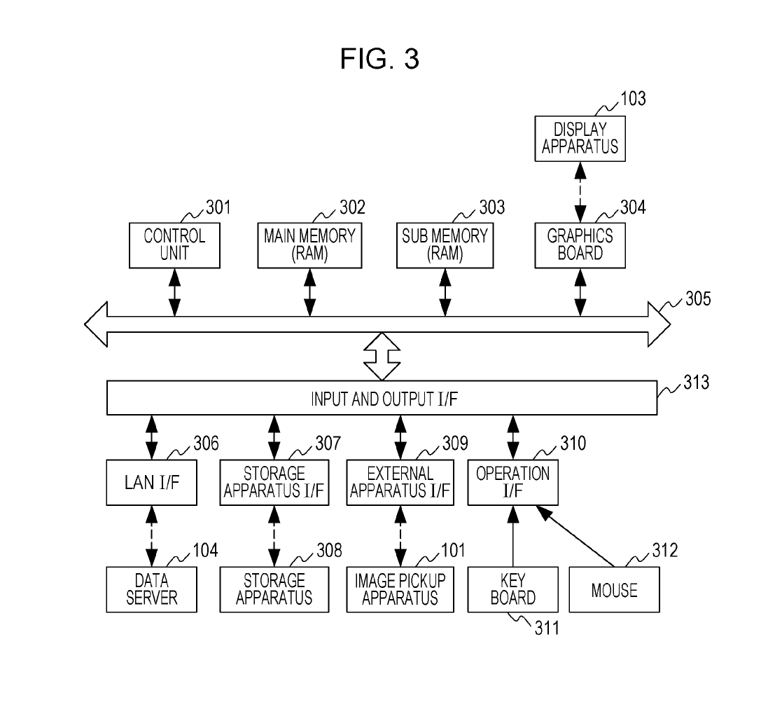

FIG. 3 is a block diagram of a hardware configuration of the image processing apparatus according to the present embodiment. A personal computer (PC) is used for an apparatus that performs information processing, for example. The PC is provided with a control unit 301, a main memory 302, a sub memory 303, a graphics board 304, an internal bus 305 mutually connecting those components, a LAN I/F 306, a storage apparatus I/F 307, an external apparatus I/F 309, an operation I/F 310, and an input and output I/F 313.

The control unit 301 appropriately accesses the main memory 302, the sub memory 303, and the like and controls the respective entire blocks of the PC in an overall manner while respective computation processings are conducted. The main memory 302 and the sub memory 303 are structured as a RAM (Random Memory Access). The main memory 302 is used as a work area or the like for the control unit 301. The main memory 302 temporarily holds an OS, various programs, and various types of data corresponding to the processing targets such as the generation of the display data. The main memory 302 and the sub memory 303 are also used as a storage area for the image data. High speed transfer of the image data between the main memory 302 and the sub memory 303 and between the sub memory 303 and the graphics board 304 can be realized with a DMA (Direct Memory Access) function of the control unit 301. The graphics board 304 outputs an image processing result to the display apparatus 103. The display apparatus 103 is, for example, a display device using liquid crystal, EL (Electro-Luminescence), or the like. It is assumed that the display apparatus 103 is connected as an external apparatus, but the PC integrated with the display apparatus may be conceivable. A laptop PC corresponds to this apparatus, for example.

The data server 104 is connected to the input and output I/F 313 via the LAN I/F 306. The storage apparatus 308 is connected to the input and output I/F 313 via the storage apparatus I/F 307. The image pickup apparatus 101 is connected to the input and output I/F 313 via the external apparatus I/F 309. A key board 311 and a mouse 312 are connected to the input and output I/F 313 via the operation I/F 310.

The storage apparatus 308 is an auxiliary storage apparatus that records and reads out information where the OS executed by the control unit 301, the programs, the various parameters, and the like are statically stored as firmware. The storage apparatus 308 is used as a storage area for the hierarchical image data sent from the image pickup apparatus 101. A magnetic disk drive such as an HDD (Hard Disk Drive) or an SSD (Solid State Disk) or a semiconductor device using a flash memory is used for the storage apparatus 308.

A pointing device such as the key board 311 or the mouse 312 is assumed as a connecting device with the operation I/F 310, but a screen of the display apparatus 103 functioning as a direct input device such as a touch panel can also be used. The touch panel may be integrated with the display apparatus 103 in that case.

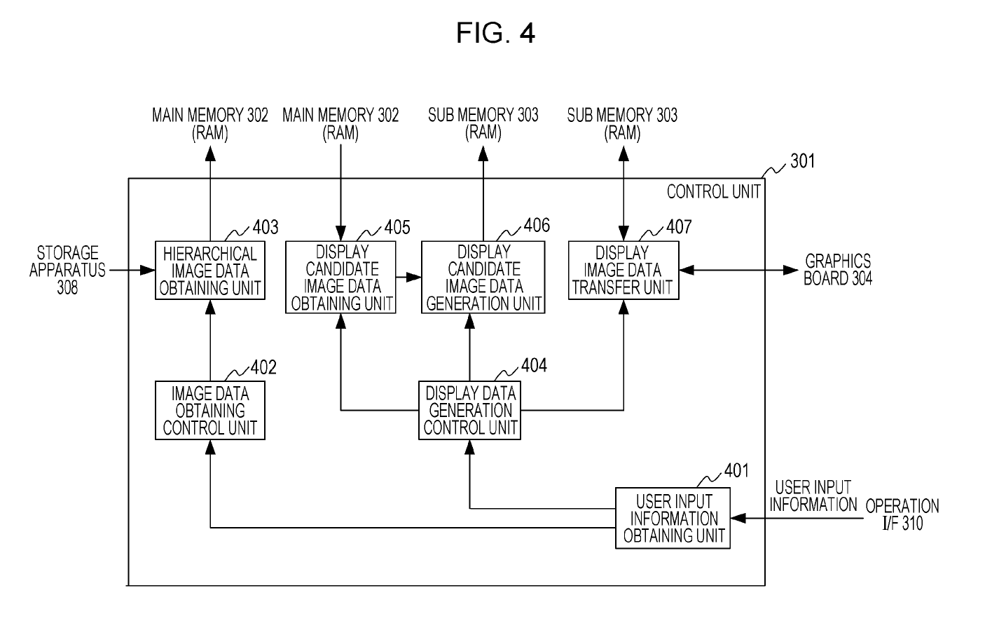

FIG. 4 is a block diagram of a function configuration of the control unit 301 of the image processing apparatus according to the present embodiment. The control unit 301 is composed of a user input information obtaining unit 401, an image data obtaining control unit 402, a hierarchical image data obtaining unit 403, a display data generation control unit 404, a display candidate image data obtaining unit 405, a display candidate image data generation unit 406, and a display image data transfer unit 407.

The user input information obtaining unit 401 obtains instruction contents input to the key board 311 and the mouse 312 by the user such as start or end of the image display, display image scroll operation, and expansion or reduction (magnification change) via the operation I/F 310. The user input information obtaining unit 401 is equivalent to a detection unit. In the present specification, the scroll is processing where an image that is not displayed on a screen (display unit) of the display apparatus is displayed onto the screen through a user input operation. The scroll of course includes a scroll in an X direction and scroll in a Y direction and also a scroll in a Z direction.

The image data obtaining control unit 402 controls an area for the image data read out from the storage apparatus 308 and expanded to the main memory 302 on the basis of the user input information. The image area predicted to be used as the display image is determined in response to various pieces of user input information such as the start or end of the image display, the display image scroll operation, and the expansion or reduction. In a case where the main memory 302 does not hold the image area, the hierarchical image data obtaining unit 403 is instructed to perform the read of the image area from the storage apparatus 308 and the expansion to the main memory 302. Since the read from the storage apparatus 308 is time-consuming processing, overhead on this processing is preferably suppressed while a range of the read image area is set as wide as possible.

The hierarchical image data obtaining unit 403 performs the read of the image area from the storage apparatus 308 and the expansion to the main memory 302 while following a control instruction of the image data obtaining control unit 402.

The display data generation control unit 404 controls the image area read out from the main memory 302 and the processing method therefor and the display image area transferred to the graphics board 304 on the basis of the user input information. The image area for a display candidate predicted to be used as the display image and the display image area actually displayed on the display apparatus 103 are detected on the basis of various pieces of user input information such as the start or end of the image display, the display image scroll operation, and the expansion or reduction. If the sub memory 303 does not hold the image area for the display candidate, the display candidate image data obtaining unit 405 is instructed to read out the image area for the display candidate from the main memory 302. The display candidate image data generation unit 406 is instructed at the same time to perform a processing method with respect to a scroll request. The display image data transfer unit 407 is instructed to read out the display image area from the sub memory 303. As compared with the read of the image data from the storage apparatus 308, the read from the main memory 302 can be executed at a higher speed. Thus, the image area for the display candidate has a narrower range as compared with the wide range image area in the image data obtaining control unit 402.

The display candidate image data obtaining unit 405 executes the read of the image area for the display candidate from the main memory 302 to be transferred to the display candidate image data generation unit 406 while following the control instruction of the display data generation control unit 404.

The display candidate image data generation unit 406 executes extension processing on the display candidate image data corresponding to the compressed image data to be expanded to the sub memory 303. The display candidate image data generation unit 406 can execute expansion processing on the low resolution image data and reduction processing on the high resolution image data as described below. The display candidate image data generation unit 406 is equivalent to a display image generation unit.

The display image data transfer unit 407 executes the read of the display image from the sub memory 303 to be transferred to the graphics board 304 while following the control instruction of the display data generation control unit 404. The high speed image data transfer between the sub memory 303 and the graphics board 304 is executed with the DMA function.

FIG. 5 is a frame format of a hierarchical image data structure according to the present embodiment. The hierarchical image data structure is composed herein with four layers of a first layer image 501, a second layer image 502, a third layer image 503, and a fourth layer image 504 depending on a difference in resolution. A sample 505 is a tissue slice or smear cell corresponding to an observation target. Sizes of the sample 505 in the respective layers are illustrated to visually understand the hierarchical structure. The first layer image 501 is an image having a lowest resolution and is used for a thumbnail image or the like. The second layer image 502 and the third layer image 503 are images having medium-level resolutions and are used for a wide range observation of a virtual slide image or the like. The fourth layer image 504 is an image having a highest resolution and is used when the virtual slide image is observed in detail.

The images of the respective layers are composed by aggregating several compressed image blocks. The compressed image block is a single JPEG image in the case of the JPEG compression format, for example. The first layer image 501 is composed of a single block of the compressed image herein. The second layer image 502 is composed of four blocks of the compressed image. The third layer image 503 is composed of 16 blocks of the compressed image. The fourth layer image 504 is composed of 64 blocks of the compressed image.

The difference in the resolution of the image corresponds to a difference in optical magnification at the time of the microscopic observation. The first layer image 501 is equivalent to the microscopic observation at a low magnification. The fourth layer image 504 is equivalent to the microscopic observation at a high magnification. In a case where the user wishes to conduct the observation at the high magnification, for example, it is possible to conduct the detailed observation corresponding to the observation at the high magnification by displaying the fourth layer image 504.

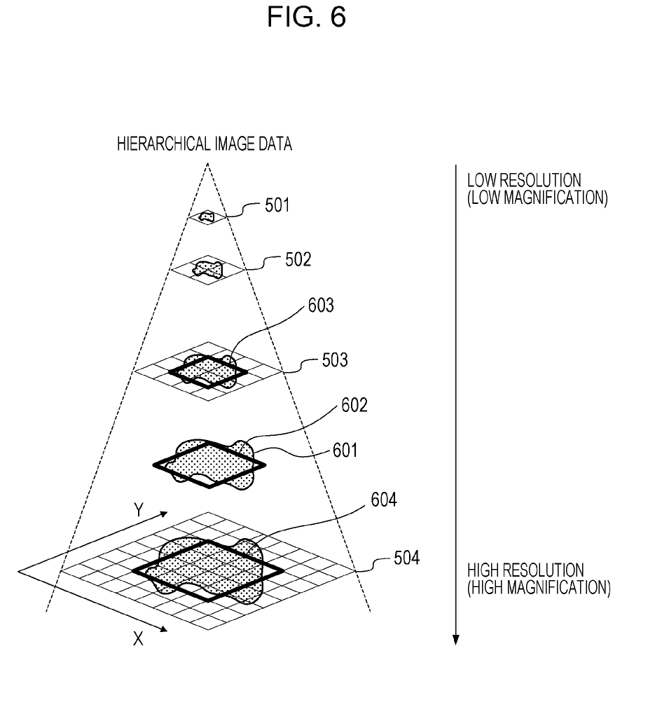

FIG. 6 is a frame format of the hierarchical image data where the display area according to the present embodiment is illustrated.

A consideration will be given of an observation on a sample 601 at an arbitrary resolution (magnification). The arbitrary resolution (magnification) is set as a resolution (magnification) between the third layer and the fourth layer. A display area 602 represents an area of the sample 601 displayed by the display apparatus 103 at the arbitrary resolution (magnification). Since the image data regarding the resolution of the display image does not exist in the hierarchical structure at this time, the display image is to be generated from the image data in an adjacent layer.

The original image in a case where the display area 602 is generated from the third layer image 503 on the third layer is a low resolution display area 603. The display area 602 is generated through enlargement processing on the low resolution display area 603. The low resolution display area 603 is equivalent to the four blocks of the compressed image.

It will be appreciated that, in addition to the third layer image 503 immediately adjacent to the sample 601, the display image can also be generated by other layer images having resolutions lower than the sample 601. For example, the display image can also be generated from the first layer image 501 or the second layer image 502.

The original image in a case where the display area 602 is generated from the fourth layer image 504 on the fourth layer is a high resolution display area 604. The display area 602 is generated through reduction processing on the high resolution display area 604. The high resolution display area 604 is equivalent to the 16 blocks of the compressed image.

In the example as shown in FIG. 6, the display area 604 is generated by reduction processing performed on the fourth layer image 504 having a high resolution than the resolution of the sample 601. It will be appreciated that the reduction processing can also be performed on other layer image that has higher resolutions than the arbitrary resolution of the sample 601 when there are more than one layer image having resolutions higher than the resolution of the sample 601.

In the enlargement processing and the reduction processing, an interpolation method such as a nearest neighbor method, a bilinear method, or a bicubic method is used to obtain pixel values after the enlargement and the reduction.

While the low resolution display area 603 is composed of the four blocks of the compressed image, the high resolution display area 604 is composed of the 16 blocks of the compressed image. When a processing time related to the read of the image is taken into account, the higher speed processing is realized by using the low resolution display area 603 corresponding to the lower number of the compressed image blocks. When an image quality after the image generation is taken into account, the high accuracy image reproduction can be realized by using the high resolution display area 604 having the higher sampling number.

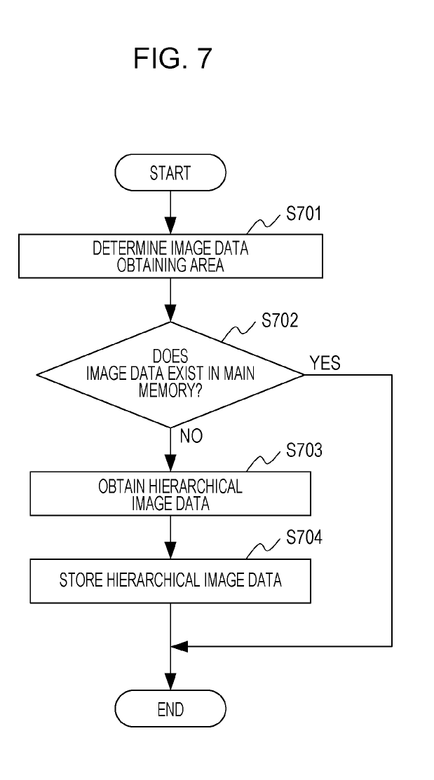

FIG. 7 is a flow chart for describing an obtaining method for the hierarchical image data according to the present embodiment. This flow is executed by the image data obtaining control unit 402 and the hierarchical image data obtaining unit 403 on the basis of the user input information in the user input information obtaining unit 401.

In step S701, an image data obtaining area is determined. In response to various pieces of user input information such as the start or end of the image display, the display image scroll operation, and the expansion or reduction. The image area predicted to be used as the display image is determined. This flow is for executing the read from the storage apparatus 308. Since this processing takes time, overhead on this processing is preferably suppressed while a range of the read image area is set as wide as possible.

In step S702, it is determined whether or not the image data on the image area decided in S701 is stored in the main memory 302. When the main memory 302 holds the image data on the image area, the processing is ended. When the main memory 302 does not hold the image data on the image area, the flow proceeds to S703.

In step S703, the image data on the image area is obtained from the storage apparatus 308.

In step S704, the image data obtained from the storage apparatus 308 is stored in the main memory 302.

FIG. 8 is a flow chart for describing a generation method for the display candidate image data according to the present embodiment. This flow is executed by the display data generation control unit 404, the display candidate image data obtaining unit 405, and the display candidate image data generation unit 406 on the basis of the user input information in the user input information obtaining unit 401.

In step S801, it is determined whether or not the user input information in the user input information obtaining unit 401 is a scroll request. When the user input information is not the scroll request, the processing is ended. When the user input information is the scroll request, the flow proceeds to S802.

In step S802, the image area for the display candidate predicted to be used as the display image is detected from the scroll direction, the scroll speed, and the currently displayed area corresponding to the user input information.

In step S803, it is determined whether or not the image data on the image area detected in S802 is stored in the sub memory 303. When the sub memory 303 holds the image data on the image area, the processing is ended. When the sub memory 303 does not hold the image data on the image area, the flow proceeds to S804.

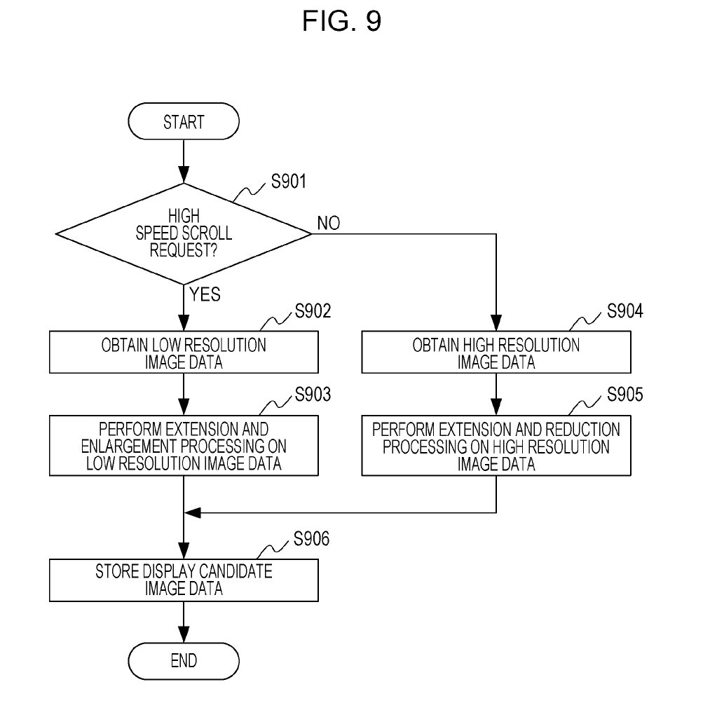

In step S804, the obtainment of the display candidate image data from the main memory 302, the extension processing on the display candidate image data corresponding to the compressed image data, and the storage into the sub memory 303 are conducted. A detail of the processing in S804 will be described by using FIG. 9.

FIG. 9 is a flow chart for describing a data processing method in response to a scroll request according to the present embodiment.

In step S901, it is determined whether or not the user input information in the user input information obtaining unit 401 is a high speed scroll request. In a case where it is determined that the user input information is the high speed scroll request, the flow proceeds to S902. In a case where it is not determined that the user input information is the high speed scroll request (a case where a low speed scroll request is determined as the user input information), the flow proceeds to S905. The high speed scroll in the present specification is defined as a scroll operation at a speed at which the user does not recognize the display content. The low speed scroll is defined as a scroll operation at a speed at which the user can recognize the display content. The determination on whether the scroll is the high speed scroll or the low speed scroll is conducted while a predetermined threshold (predetermined value) is set as a reference for a movement speed of the mouse, for example. In a case where the speed is higher than or equal to the threshold, the scroll may be determined as the high speed scroll, and in a case where the speed is lower than or equal to the threshold, the scroll may be determined as the low speed scroll. The predetermined threshold (predetermined value) may of course be variable. The predetermined threshold may vary, for example, in accordance with the size of the processed image.

In step S902, low resolution image data is obtained from the main memory 302. The low resolution image data corresponds to the low resolution display area 603 illustrated in FIG. 6. The resolution image data includes the four blocks of the compressed image and therefore has a merit that a data transfer time is short.

In step S903, the extension processing (decompression processing on the compressed image) and the enlargement processing on the low resolution image data obtained in S902 are executed to generate the display candidate image data. The image quality of the display candidate image data is degraded as compared with the reduction processing on the high resolution image because of the enlargement processing on the low resolution image. However, since the scroll speed is so high that the user does not recognize the display content, the user does not have sense of discomfort.

In step S904, the high resolution image data is obtained from the main memory 302. The high resolution image data corresponds to the high resolution display area 604 illustrated in FIG. 6.

In step S905, the extension processing (decompression on the compressed image) and the reduction processing on the high resolution image data obtained in S904 are executed to generate the display candidate image data. The high resolution image data includes the 16 blocks of the compressed image, and it therefore takes time to transfer the image data. However, since the update area of the display image at the low speed scroll is small, the transfer speed is hardly affected.

In step S906, the display candidate image data generated by the display candidate image data generation unit 406 in S903 or S905 is stored in the sub memory 303.

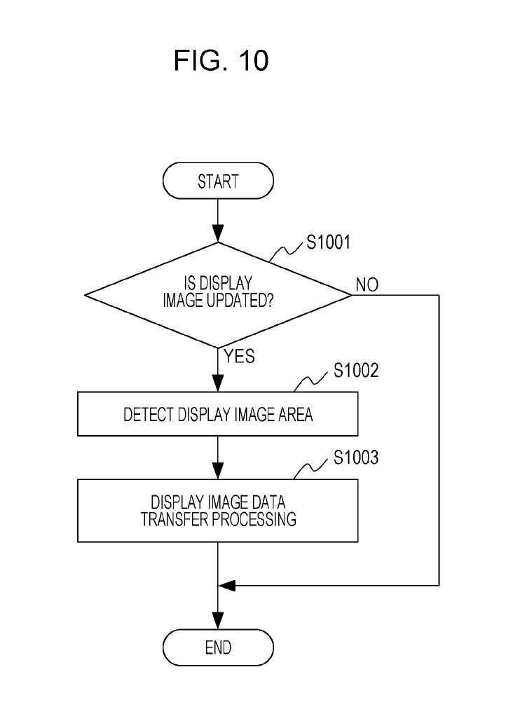

FIG. 10 is a flow chart for describing a display image data transfer method according to the present embodiment. This flow is executed by the display data generation control unit 404 and the display image data transfer unit 407 on the basis of the user input information in the user input information obtaining unit 401.

In step S1001, it is determined whether or not the display image is updated on the basis of the user input information in the user input information obtaining unit 401. The display image is updated when the instruction content is the start or end of the display image, the display image scroll operation, the enlargement or reduction, or the like. When the display image is updated, the flow proceeds to S1002, and when the display image is not updated, the processing is ended.

In step S1002, the area of the display image to be updated is detected from the scroll direction, the scroll speed, and the like corresponding to the user input information.

In step S1003, display image data transfer processing is conducted. The high speed image data transfer between the sub memory 303 and the graphics board 304 is executed with the DMA function.

As described above by using FIG. 1 to FIG. 10, it is possible to provide the scroll operation with the excellent responsiveness by utilizing the characteristic in terms of the image structure of the hierarchical image data dealt with by the image processing apparatus according to the present embodiment.

Hereinafter, as a modified example of the first embodiment, a configuration will be described in which POI (Point Of Interest) information can be displayed even during the high speed scroll.

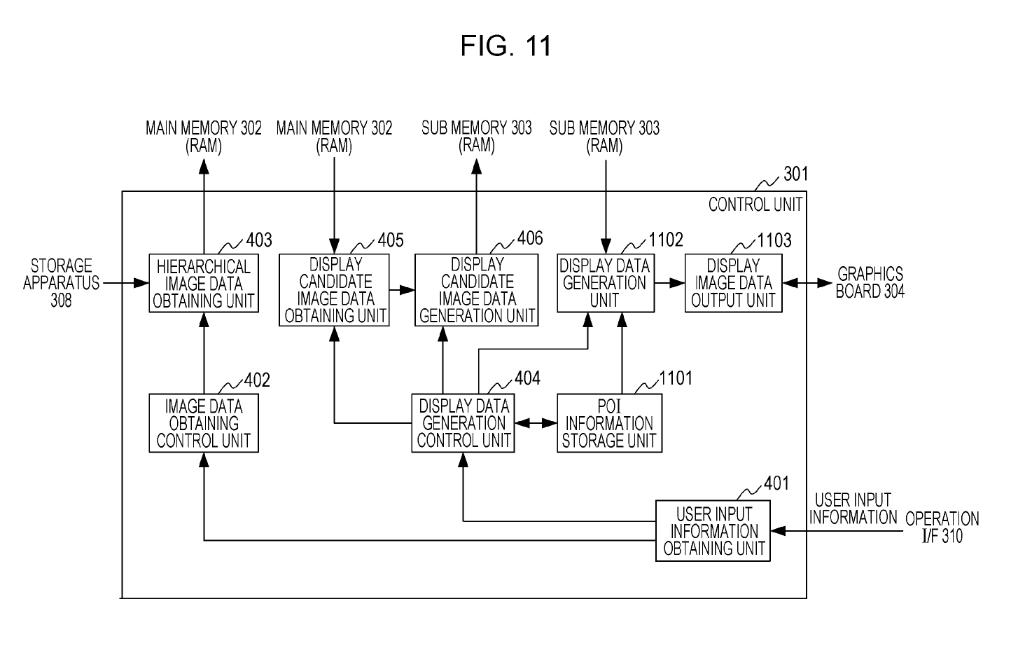

FIG. 11 is a function block diagram of the image processing apparatus to which POI information processing according to the present modified example is added. A POI information storage unit 1101, a display data generation unit 1102, and a display image data output unit 1103 are added to the function block diagram of the control unit illustrated in FIG. 4. Descriptions on function blocks and function contents similar to those of FIG. 4 will be omitted.

The display data generation control unit 404 controls the image area read out from the main memory 302 and the processing method therefor and the display image area transferred to the graphics board 304 on the basis of the user input information. The image area for the display candidate predicted to be used as the display image and the display image area actually displayed on the display apparatus 103 are detected on the basis of various pieces of user input information such as the start or end of the image display, the display image scroll operation, and the expansion or reduction. It is determined whether or not the POI information exists in the image area for the display candidate on the basis of the POI information of the POI information storage unit 1101. In a case where the POI information exists in the image area for the display candidate during the high speed scroll, the display data generation unit 1102 is instructed to draw a pop-up display of the POI information on the display image. The display candidate image data generation unit 406 and the display data generation unit 1102 are equivalent to a display image generation unit, and the display data generation control unit 404 is equivalent to a POI detection unit.

The POI information storage unit 1101 stores coordinates of the image data to which the POI information is added and the POI information. The POI information refers to information on the image area to which the user pays attention and includes not only the image area but also text data and the like. It is possible to record the POI information by using an annotation function or the like for the user to perform the observation again later, for example.

The display data generation unit 1102 reads out the display image area actually displayed on the display apparatus 103 from the sub memory 303. In a case where the POI information exists in the image area for the display candidate during the high speed scroll, a pop-up display of the POI information is drawn on the display image. An example of the pop-up display is illustrated in FIG. 19.

The display image data output unit 1103 transfers the display image data generated in the display data generation unit 1102 to the graphics board 304.

The image area for the display candidate is searched for (by pre-reading the display area), and the drawing of the POI information is executed on the display image (instead of the image area for the display candidate), so that the recognition of the POI information is facilitated even during the high speed scroll.

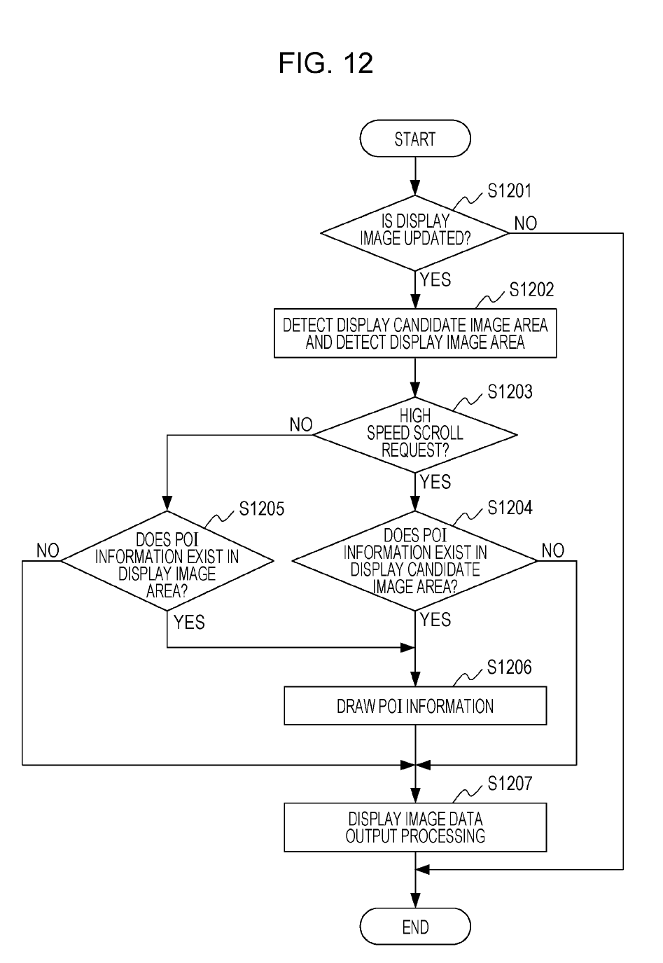

FIG. 12 is a flow chart for describing a display image data output to which the POI information processing is added according to the present modified example. This flow is executed by the display data generation control unit 404, the POI information storage unit 1101, the display data generation unit 1102, and the display image data transfer unit 407 on the basis of the user input information in the user input information obtaining unit 401. This flow is executed only in a case where the user input information is the scroll request.

In step S1201, it is determined whether or not the user input information in the user input information obtaining unit 401 is the scroll request. When the user input information is the scroll operation of the display image, the flow proceeds to S1202. When the user input information is not the scroll operation, the processing is ended.

In step S1202, the area of the display candidate image and the area of the display image to be updated are detected from the scroll direction, the scroll speed, and the like corresponding to the user input information.

In step S1203, it is determined whether or not the user input information is the high speed scroll request. When user input information is the high speed scroll request, the flow proceeds to S1204. When the user input information is not the high speed scroll request (in the case of the low speed scroll), the flow proceeds to S1205.

In step S1204, it is determined whether or not the POI information exists in the area of the display candidate image. When the POI information exists, the flow proceeds to S1206. When the POI information does not exist, the flow proceeds to S1207.

In step S1205, it is determined whether or not the POI information exists in the area of the display image to be updated. When the POI information exists, the flow proceeds to S1206. When the POI information does not exist, the flow proceeds to S1207.

In step S1206, the drawing of the POI information is executed on the display image to be updated to generate display image data. In the case of the high speed scroll request, the drawing of the POI information existing in the image area for the display candidate (instead of the display image area) is executed. In the case of the low speed scroll, the drawing of the POI information existing in the display image area is executed.

In step S1207, the generated display image data is output to the graphics board 304.

FIG. 19 illustrates an example of the pop-up display according to the present modified example. FIG. 19 illustrates an example of the drawing of the POI information existing in the image area for the display candidate instead of the display image area in the case of the high speed scroll request. During the high speed scroll in a left direction on the screen, the POI information exists at a scroll destination in the left direction on the screen, and a content of which is drawn.

As described above by using FIG. 11, FIG. 12, and FIG. 19, the user easily recognize that the POI is displayed on the display apparatus even during the high speed scroll.

Hereinafter, a description will be given of a display image generation from a low resolution image utilizing in-focus degrees of Z-stack images (plural depth images) as another modified example of the first embodiment.

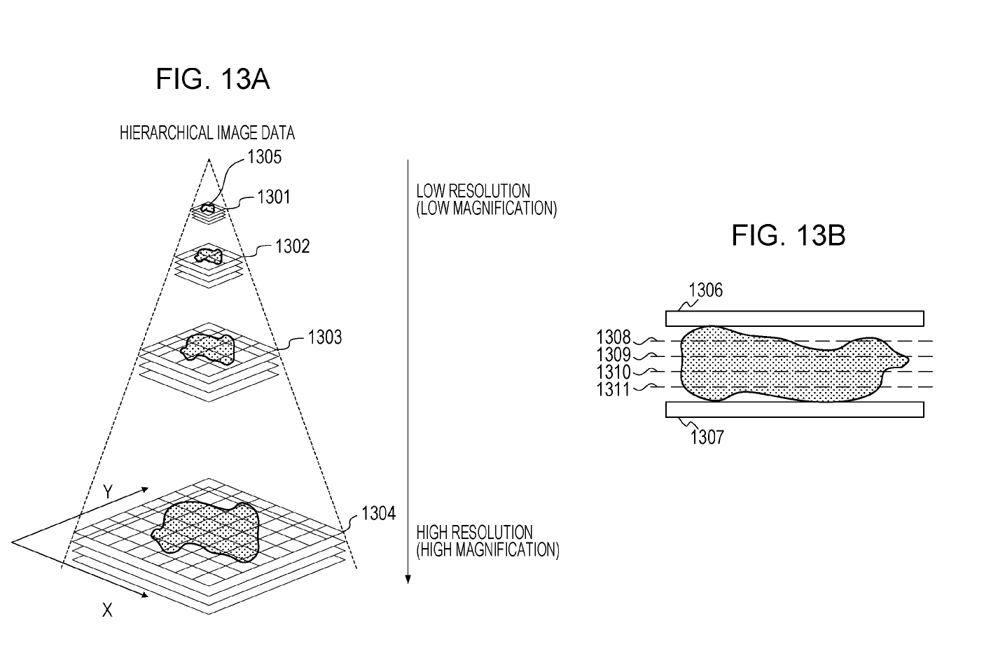

FIG. 13A is a frame format of the hierarchical image data to which a depth structure is added according to the present modified example. Similarly as in the structure of the hierarchical image data illustrated in FIG. 5, the structure is composed of four layers including a first layer depth image group 1301, a second layer depth image group 1302, a third layer depth image group 1303, and a fourth layer depth image group 1304 depending on a difference in the resolution. The depth structure is taken into account in each of the layers, which is different from FIG. 5, and the respective layers have four depth images each. A sample 1305 is a tissue slice or smear cell corresponding to an observation target. The size of the sample 505 is illustrated in each of the layers to visually understand the hierarchical structure. The first layer depth image group 1301 is an image having a lowest resolution and is used for the thumbnail image or the like. The second layer depth image group 1302 and the third layer depth image group 1303 are images having medium-level resolutions and are used for the wide range observation of the virtual slide image or the like. The fourth layer depth image group 1304 is an image having a highest resolution and is used when the virtual slide image is observed in detail.

The images of the respective layers are composed by aggregating several compressed image blocks. The compressed image block is a single JPEG image in the case of the JPEG compression format, for example. The first layer image 501 herein is composed of a single block of the compressed image herein. The second layer image 502 is composed of four blocks of the compressed image. The third layer image 503 is composed of 16 blocks of the compressed image. The fourth layer image 504 is composed of 64 blocks of the compressed image.

The difference in the resolution of the image corresponds to a difference in optical magnification at the time of the microscopic observation. The first layer depth image group 1301 is equivalent to the microscopic observation at a low magnification. The fourth layer depth image group 1304 is equivalent to the microscopic observation at a high magnification. In a case where the user wishes to conduct the observation at the high magnification, for example, it is possible to conduct the detailed observation corresponding to the observation at the high magnification by displaying the fourth layer depth image group 1304.

FIG. 13B is a frame format of for describing the depth structure. FIG. 13B illustrates a cross section of the slide 206. The slide 206 has a sample (a tissue slice or smear cell corresponding to an observation target) affixed on slide glass 1307 and is fixed under cover glass 1306 with mounting agent. The sample is a transparent body having a thickness from approximately several μm to several tens of μm. The user observes several surfaces different in the depth of the sample (depth direction location (Z direction location)). A first depth image 1308, a second depth image 1309, a third depth image 1310, and a fourth depth image 1311 are considered herein as the observation surfaces different in the depth. Depth image groups corresponding to the respective layers of FIG. 13A represent four depth image groups of FIG. 13B.

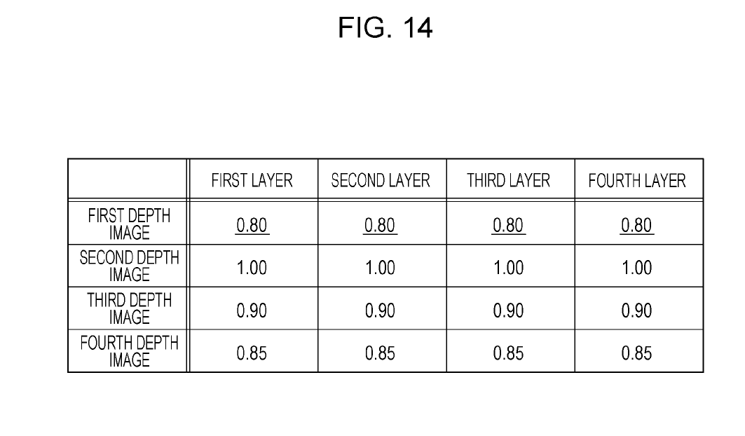

FIG. 14 is a frame format for describing an in-focus degree of the depth image according to the present embodiment. FIG. 14 illustrates an example of a table of the respective depth images and respective pieces of in-focus information (image contrast). The in-focus information (image contrast) of the first depth image has a lowest value on the first layer, which corresponds to the image having a lowest in-focus degree. Similarly, the first depth image corresponds to the image having a lowest in-focus degree on the second layer to the fourth layer as well.

The image contrast can be calculated by the following expression in a case where the image contrast is set as E and a luminance component of a pixel is set as L (m, n). Here, m represents a Y direction location of the pixel, and n represents an X direction location of the pixel.

E=Σ(L(m,n+1)−L(m,n))²+Σ(L(m+1,n)−L(m,n))²

A first term of the right side represents a luminance difference of pixels adjacent in the X direction, and a second term represents a luminance difference of pixels adjacent in the Y direction. The image contrast E is an index representing a square sum of the differences of the pixels adjacent in the X direction and the Y direction. Values obtained by normalizing the image contrast E between 0 and 1 are used in FIG. 14.

The example in which the respective pixels of the in-focus information on the first layer to the fourth layer are held has been illustrated herein. However, it is conceivable that a tendency of the in-focus information in which the first depth image has the lowest in-focus degree and the second depth image has the highest in-focus degree generally does not depend on a difference in the resolution (magnification) (does not depend on a difference in the layer). For that reason, a simplification can also be realized by holding only the in-focus information on the fourth layer.

The in-focus degree of the depth image can be detected by obtaining the image contrast at the time of the generation of the hierarchical image data as part of the processing in the compression processing unit 218 illustrated in FIG. 2. Thus, the compression processing unit 218 is equivalent to an in-focus degree detection unit.

FIG. 15 is a flow chart for describing an insufficiently-focused image data processing in response to the high speed scroll request according to the present modified example. The same contents as the image data processing in response to the scroll request described in FIG. 9 are assigned with the same reference signs, and a description thereof will be omitted.

In step S1501, insufficiently-focused image data at a low resolution is obtained form the main memory 302. The insufficiently-focused image data corresponds to the image data having the lowest image contrast among the depth images illustrated in FIG. 14.

In step S1502, the extension processing (decompression on the compressed image) and the enlargement processing on the insufficiently-focused image data at the low resolution obtained in step S1501 are executed to generate the display candidate image data. Because of the enlargement processing on the low resolution and insufficiently-focused image, the display candidate image is a blurred image. For that reason, a situation in which the image is moved at the high speed in the high speed scroll can be represented in a simulated manner, and the user can sense the natural high speed scroll.

As described above by using FIG. 13 to FIG. 15, the situation in which the image is moved at the high speed in the high speed scroll can be represented in a simulated manner by generating the display image using the insufficiently-focused image data at the low resolution the high speed scroll, and the user can sense the natural high speed scroll.

### Second Embodiment

The image processing system, the function block of the image pickup apparatus in the image processing system, the hardware configuration, the function block of the control unit, the hierarchical image data structure, and the hierarchical image data obtaining flow according to the present embodiment are similar to the contents described from FIG. 1 to FIG. 7 according to the first embodiment, and a description thereof will be omitted.

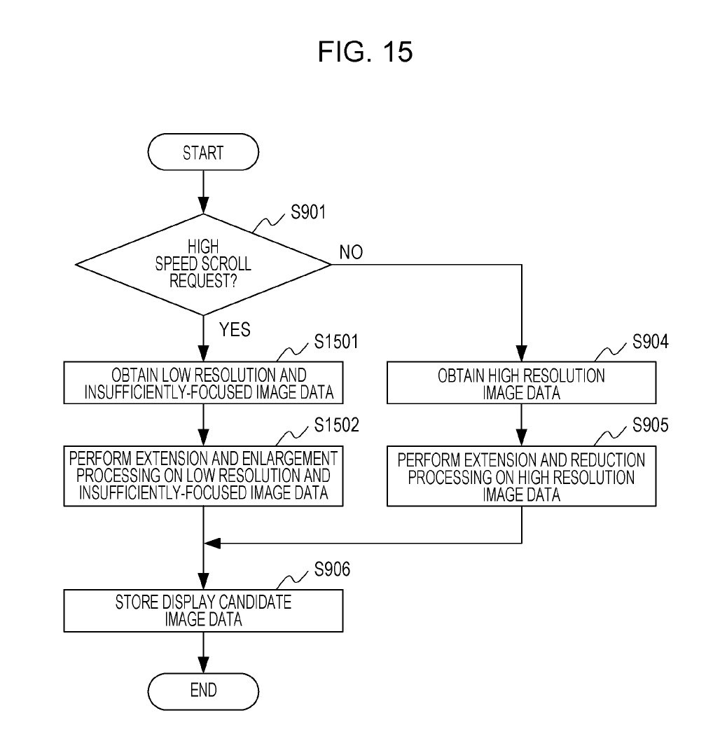

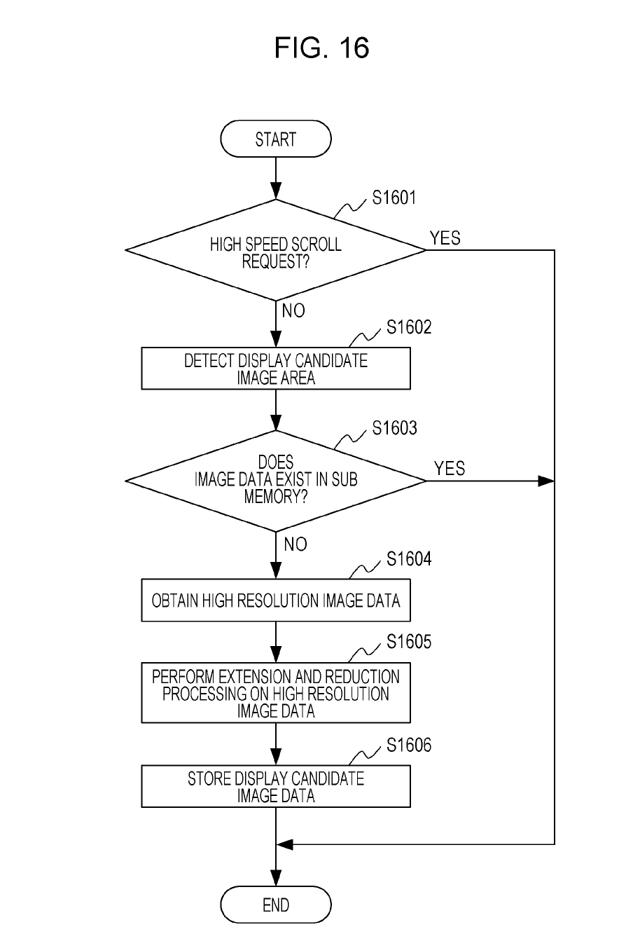

FIG. 16 is a flow chart for describing an image data processing method in response to the low speed scroll request according to the present embodiment. This flow is executed by the display data generation control unit 404, the display candidate image data obtaining unit 405, and the display candidate image data generation unit 406 on the basis of the user input information in the user input information obtaining unit 401. This flow is executed only in a case where the user input information is the scroll request. The user input information obtaining unit 401 is equivalent to a detection unit, and the display data generation control unit 404 is equivalent to a display control unit.

In step S1601, it is determined whether or not the user input information in the user input information obtaining unit 401 is a high speed scroll request. In a case where the user input information is the high speed scroll request, the processing is ended. In a case where the user input information is not the high speed scroll request (in the case of the low speed scroll), the flow proceeds to S1602.

In step S1602, the image area for the display candidate predicted to be used as the display image is detected from the scroll direction, the scroll speed, and the currently displayed area corresponding to the user input information.

In step S1603, it is determined whether or not the image data on the image area detected in S1602 is stored in the sub memory 303. When the sub memory 303 holds the image data on the image area, the processing is ended. When the sub memory 303 does not hold the image data on the image area, the flow proceeds to S1604.

In step S1604, the high resolution image data is obtained from the main memory 302. The high resolution image data corresponds to the high resolution display area 604 illustrated in FIG. 6.

In step S1605, the extension processing (decompression on the compressed image) and the reduction processing on the high resolution image data obtained in S1604 are executed to generate the display candidate image data. The high resolution image data includes the 16 blocks of the compressed image, and it therefore takes time to transfer the image data. However, since the update area of the display image at the low speed scroll is small, the transfer speed is hardly affected.

In step S1606, the display candidate image data generated in S1605 is stored in the sub memory 303.

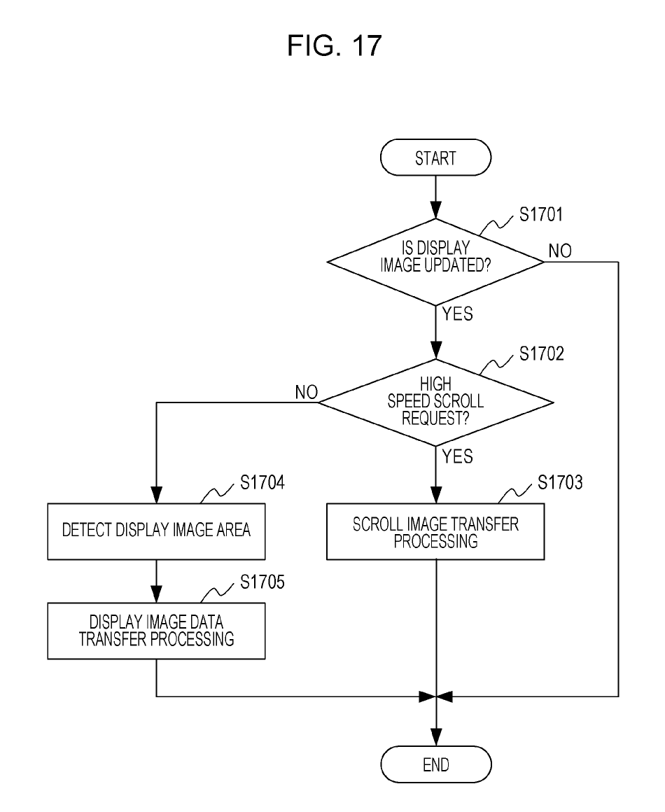

FIG. 17 is a flow chart for describing a display image data output method in response to the high speed scroll request according to the present embodiment. This flow is executed by the display data generation control unit 404 and the display image data transfer unit 407 on the basis of the user input information in the user input information obtaining unit 401. This flow is executed only in a case where the user input information is the scroll request.

In step S1701, it is determined whether or not the display image is updated on the basis of the user input information in the user input information obtaining unit 401. The display image is updated when the instruction content is the start or end of the display image, the display image scroll operation, the enlargement or reduction, or the like. When the display image is updated, the flow proceeds to S1002, and when the display image is not updated, the processing is ended.

In step S1702, it is determined whether or not the user input information in the user input information obtaining unit 401 is a high speed scroll request. In a case where the user input information is not the high speed scroll request (in the case of the low speed scroll request), the processing is ended. In a case where the user input information is the high speed scroll request, the flow proceeds to S1703.

In step S1703, transfer processing is conducted on a scroll image corresponding to a display image to be updated on the basis of the scroll direction, the scroll speed, and the like corresponding to the user input information. The scroll image is generated in advance in accordance with the scroll direction and the scroll speed and stored in the sub memory 303.

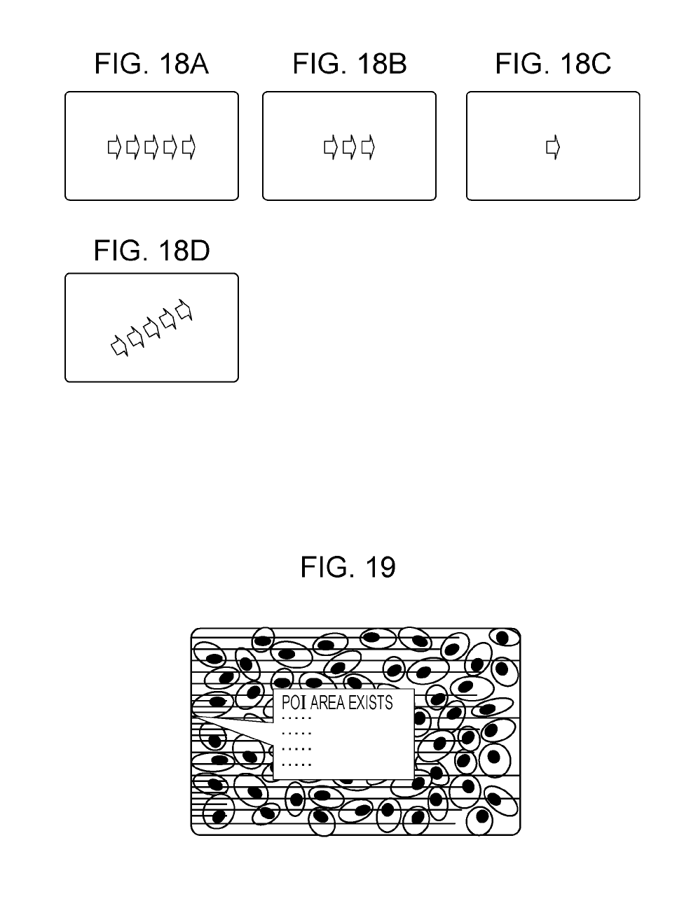

The scroll image is an image generated without using the data of the picked-up image that is actually obtained in the image pickup apparatus. The scroll image is, for example, a CG (Computer Graphics) image. Examples of the scroll image will be described in FIGS. 18A to 18D. The user input information obtaining unit 401 is equivalent to a direction detection unit.

In step S1704, the area of the display image to be updated is detected from the scroll direction, the scroll speed, and the like corresponding to the user input information.

In step S1705, display image data transfer processing is conducted. The high speed image data transfer between the sub memory 303 and the graphics board 304 is executed with the DMA function.

FIGS. 18A to 18D illustrate examples of the scroll image according to the present embodiment. FIGS. 18A to 18C illustrate CG image examples displayed during the high speed scroll in the right direction on the screen. The scroll speed is represented by the number of arrows. As the scroll speed is higher, the number of arrows is increased. Although the high speed scroll is represented by the arrows, the high speed scroll may be represented, for example, by dynamic lines in a cartoon manner. FIG. 18D illustrates a CG image example displayed duding the high speed scroll in an upper right direction on the screen.

The scroll image is a CG image specifying an attribute of the user input information (user request) such as the scroll direction and the scroll speed. The user can easily recognize the conduction of the high speed scroll and the direction and the speed by using the CG image that is different from the actual image. The scroll image is not limited to the image examples of FIGS. 18A to 18D. In FIGS. 18A to 18D, for example, only the CG image is displayed on the entire screen instead of the actual image, but the actual image before the scroll may be used on a background to display a similar CG image (only arrows) on the background. Not only the direction (speed) on the XY plane but also a Z direction (speed) or enlargement or reduction of the magnification (changed speed) may be specified.

As described above by using FIG. 16, FIG. 17, and FIGS. 18A to 18D, even in the case of the hierarchical image data dealt with by the image processing apparatus according to the present embodiment, it is possible to provide the scroll operation with the excellent responsiveness without causing the sense of discomfort in the user.

The embodiments have been described above but the present invention is not limited to those embodiments, and various modifications and variations can be made within the gist of the invention.

According to the above-described embodiments, for example, the determination on the high speed request or the low speed request is made on the basis of (the scroll speed of) the scroll request, but the determination on the high speed request or the low speed request may be made on the basis of (the changed speed of) the magnification change request to conduct similar processing.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-067578, filed Mar. 23, 2012, which is hereby incorporated by reference herein in its entirety.

What is claimed is:

1. An image processing apparatus that generates data of a display image from hierarchical image data of a plurality of layer images having different resolutions, the image processing apparatus comprising:
a detection unit configured to detect a scroll request or a magnification change request; and
a display image generation unit configured to generate the data of the display image based on the detected request,
wherein the display image generation unit determines whether the request is a high speed request or a low speed request based on a predetermined value used as a reference when the display image has a resolution different from the resolutions of the plurality of layer images,
the display image generation unit generates the display image data by performing enlargement processing on data on any of the layer images that has a resolution lower than the resolution of the display image when the detected request is determined as the high speed request, and
the display image generation unit generates the data of the display image by performing reduction processing on data on any of the layer images that has a resolution higher than the resolution of the display image when the detected request is determined as the low speed request.

2. The image processing apparatus according to claim 1,
wherein each of the plurality of layer images includes a plurality of depth images having different depths, and
wherein the display image generation unit generates the data of the display image by using data of the depth image having a low in-focus degree among the depth images of the layer image having the low resolution when the request detected by the detection unit is the high speed request.

3. The image processing apparatus according to claim 2, further comprising:
an in-focus degree detection unit configured to detect in-focus degrees of the plurality of depth images.

4. The image processing apparatus according to claim 1, further comprising:
a direction detection unit configured to detect a scroll direction; and a POI detection unit configured to detect POI,
wherein the display image generation unit generates data for performing a pop-up display of the POI when the POI is detected in the scroll direction in a case where the scroll request detected by the direction detection unit is the high speed scroll request.

5. An image processing apparatus that displays a picked-up image on a display apparatus, the image processing apparatus comprising:
a detection unit configured to detect a scroll request or a magnification change request; and
a display control unit configured to determine whether the detected request is a high speed request or a low speed request based on a predetermined value used as a reference and display an image that does not use data of the picked-up image on the display apparatus when it is determined that the detected request is the high speed request.

6. The image processing apparatus according to claim 5,
wherein the image that does not use the data of the picked-up image is an image specifying an attribute of the detected request.

7. The image processing apparatus according to claim 6,
wherein the image that does not use the data of the picked-up image is an image specifying a scroll direction.

8. The image processing apparatus according to claim 5,
wherein the image that does not use the data of the picked-up image is a CG image.

9. An image processing system provided with an image processing apparatus that generates data of a display image from hierarchical image data of a plurality of layer images having different resolutions and a display apparatus that displays the display image, the image processing system comprising:
a detection unit configured to detect a scroll request or a magnification change request; and
a display image generation unit configured to generate the data of the display image based on the detected request,
wherein the display image generation unit determines whether the detected request is a high speed request or a low speed request based on a predetermined value used as a reference when the display image has a resolution different from the resolutions of the plurality of layer images,
the display image generation unit generates the data of the display image by performing enlargement processing on data on any of the layer images that has a resolution lower than the resolution of the display image when the detected request is determined as the high speed request, and
the display image generation unit generates the data of the display image by performing reduction processing on data on any of the layer images that has a resolution higher than the resolution of the display image among the plurality of layer images when the detected request is determined as the low speed request.

10. An image processing system provided with a display apparatus and an image processing apparatus that displays a picked-up image on the display apparatus, the image processing system comprising:
a detection unit configured to detect a scroll request or a magnification change request; and
a display control unit configured to determine whether the detected request is a high speed request or a low speed request based on a predetermined value used as a reference and display an image that does not use data of the picked-up image on the display apparatus when it is determined that the detected request is the high speed request.

11. An image processing method of generating data of a display image from hierarchical image data of a plurality of layer images having different resolutions, the image processing method comprising:
causing a computer to execute detecting a scroll request or a magnification change request; and
causing the computer to execute generating the display image data based on the detected request,
wherein the generating includes determining whether the detected request is a high speed request or a low speed request based on a predetermined value used as a reference when the display image has a resolution different from the resolutions of the plurality of layer images,
the generating includes generating the display image data by performing enlargement processing on data of any of the layer image that has a resolution lower than the resolution of the display image when the detected request is determined as the high speed request, and
the generating includes generating the display image data by performing reduction processing on data of any of the layer image that has a resolution higher than the resolution of the display image when the detected request is determined as the low speed request.

12. An image processing method of displaying a picked-up image on a display apparatus, the image processing apparatus comprising:
causing a computer to execute detecting a scroll request or a magnification change request; and
causing the computer to execute determining whether the detected request is a high speed request or a low speed request based on a predetermined value used as a reference and display an image that does not use data of the picked-up image on the display apparatus in a case where it is determined that the detected request is the high speed request.

13. A program stored in non-transitory computer-readable storage medium for causing a computer to execute the respective steps of the image processing method according to claim 11.

14. A program stored in non-transitory computer-readable storage medium for causing a computer to execute the respective steps of the image processing method according to claim 12.
